(19) United States
(12) Patent Application Publication
(10) Pub. No.: US 2020/0283193 A1
(43) Pub. Date: Sep. 10, 2020

(54) METHOD FOR FORMING A PALLET WITH PLASTIC COATED SUPPORT BLOCKS

(71) Applicant: CHEP Technology Pty Limited, Sydney (AU)

(72) Inventors: BART DE LAENDER, BRUGGE (BE); MATTHEW WOOD, DAVENPORT, FL (US); DAVID PAUL ANDERSON, III, ORLANDO, FL (US); DANIEL J. LANTZ, ORLANDO, FL (US); PAUL M. MELIA, SAINT PETERSBURG, FL (US)

(21) Appl. No.: 16/802,698

(22) Filed: Feb. 27, 2020

Related U.S. Application Data
(60) Provisional application No. 62/814,350, filed on Mar. 6, 2019.

(51) Int. Cl. B65D 19/00; B05D 1/02; B05D 7/08

(52) U.S. Cl. CPC B65D 19/0073; B65D 2519/00114; B05D 7/08; B65D 2519/00029; B65D 2519/00034; B65D 2519/00044; B65D 2519/00064; B65D 2519/00069; B65D 2519/00079; B65D 2519/00273; B65D 2519/00288; B65D 2519/00333; B65D 2519/00373; B65D 2519/00099; B65D 2519/00104; B05D 1/02

(57) ABSTRACT

A method for making a pallet includes forming a base layer, forming a cargo layer, and forming wooden support blocks. The method further includes coating the wooden support blocks with a plastic layer to form plastic coated wooden support blocks. The base and cargo layers are coupled to the plastic coated wooden support blocks, with a gap being formed therebetween for receiving a lifting member.

### RELATED APPLICATION

This application claims the benefit of provisional application Ser. No. 62/814,350 filed Mar. 6, 2019, which is hereby incorporated herein in its entirety by reference.

### TECHNICAL FIELD

The present disclosure relates to the field of pallets, and more particularly, to a method for forming a wooden pallet.

### BACKGROUND

Pallets are customarily used to transport and store goods. A pallet typically includes a top deck and a bottom deck separated by support blocks. Pallets are used to serve several purposes which include the loading of equipment, and the stacking of items for transportation and storage. A pallet needs to maintain durability to serve the particular purpose for which it is being used.

### SUMMARY

A method for making a pallet includes forming a base layer, forming a cargo layer, and forming wooden support blocks. The method further includes coating the wooden support blocks with a plastic layer to form plastic coated wooden support blocks. The base and cargo layers are coupled to the plastic coated wooden support blocks, with a gap being formed therebetween for receiving a lifting member.

Each wooden support block includes upper and lower surfaces with a pair of spaced apart sides extending therebetween. The plastic layer is on the pair of spaced apart sides but not on the upper and lower surfaces.

The coating may include adding a coloring material to the plastic layer so that each plastic coated wooden support block has a desired color.

The coating may include adding indicia to the plastic layer so that each plastic coated wooden support block displays the indicia. The indicia may be configured as a logo, for example.

The coating may include a spray coating. The plastic layer may include a polyurea layer. The plastic layer may have a thickness within a range of 20-90 mils.

The base and cargo layers may be formed as wooden base and cargo layers, with exposed wooden surfaces thereof not being coated with the plastic layer.

The cargo layer may be formed to include a pair of spaced apart connector boards, and a pair of spaced apart end deck boards on the pair of connector boards. The end deck boards may be orthogonal to the pair of connector boards. The cargo layer may further include a pair of spaced apart intermediate deck boards on the pair of connector boards, with each intermediate deck board being orthogonal to the pair of connector boards and butted against a respective end deck board.

Another aspect is directed to a pallet that includes a base layer, a cargo layer and plastic coated wooden support blocks coupled between the base and cargo layers, with a gap being formed therebetween for receiving a lifting member. Each plastic coated wooden support block includes a plastic layer on exposed sides thereof.

### BRIEF DESCRIPTION OF THE DRAWINGS

FIG. 1 is a top perspective view of a wooden pallet with plastic coated support blocks in accordance with the disclosure.

FIG. 2 is a bottom perspective view of the wooden pallet shown in FIG. 1.

FIG. 3 is a top view of the wooden pallet shown in FIG. 1.

FIG. 4 is a bottom view of the wooden pallet shown in FIG. 1.

FIG. 5 is an end view of the wooden pallet shown in FIG. 1.

FIG. 6 is a side view of the wooden pallet shown in FIG. 1.

FIG. 7 is a top perspective view of one of the plastic coated support blocks illustrated in FIG. 1.

FIG. 8 is a top view of one of the plastic coated support blocks illustrated in FIG. 7.

FIG. 9 is a flowchart illustrating a method for forming the wooden pallet illustrated in FIG. 1.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

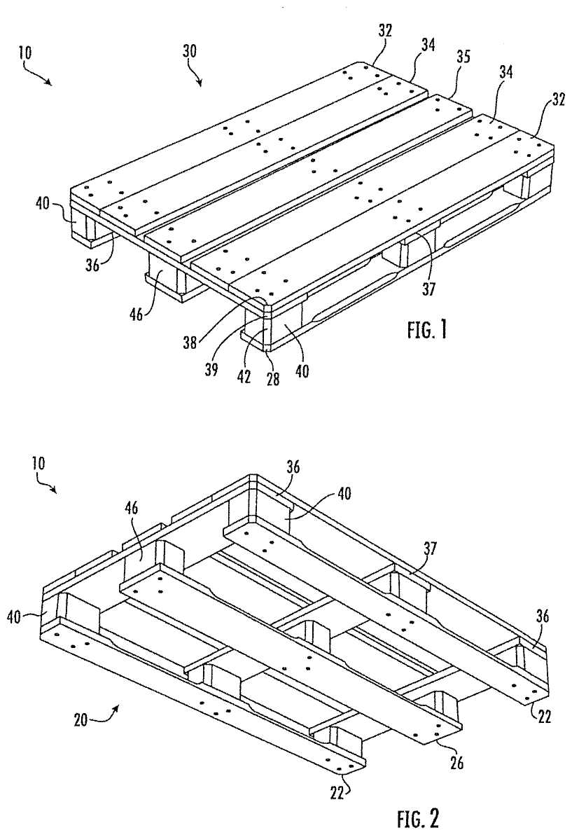

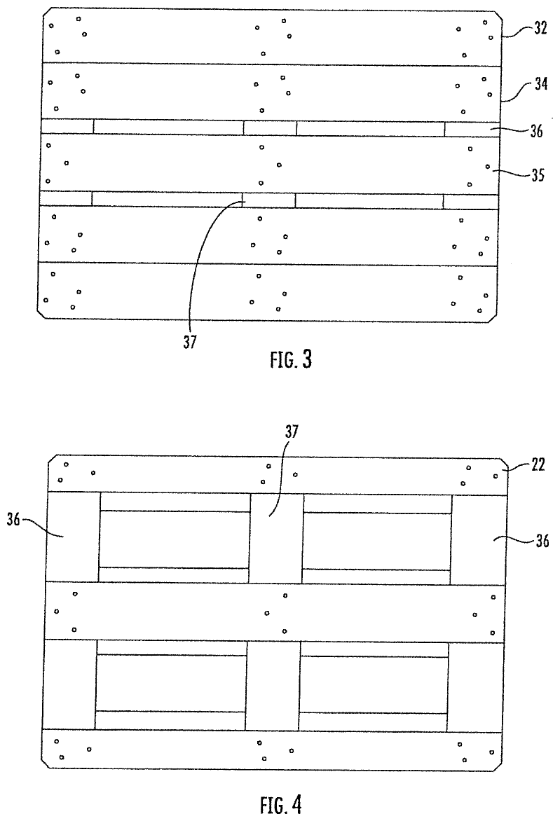

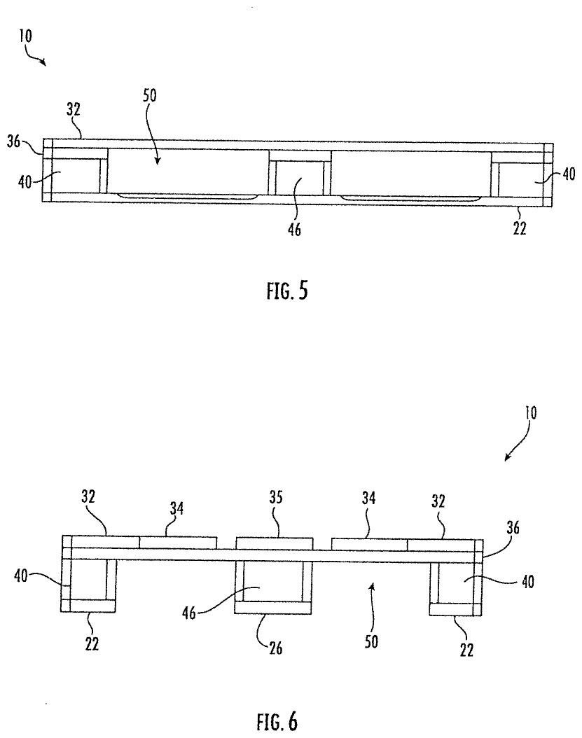

Referring initially to FIGS. 1-8, the illustrated wooden pallet 10 includes a base layer 20, a cargo layer 30, and a plurality of plastic coated wooden support blocks 40, 46 coupled between the base and cargo layers. The plastic coated support blocks 40, 46 form a gap 50 between the base and cargo layers 20, 30 for receiving a lifting member, such as fork lift tines.

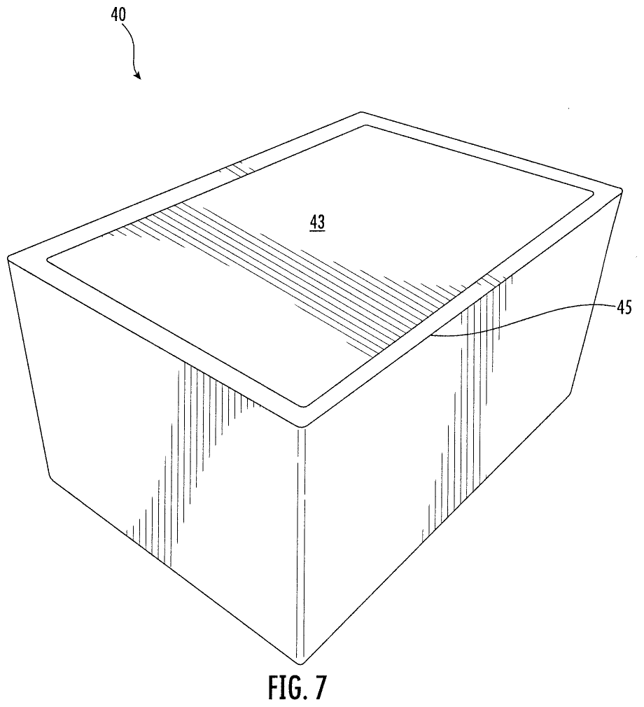

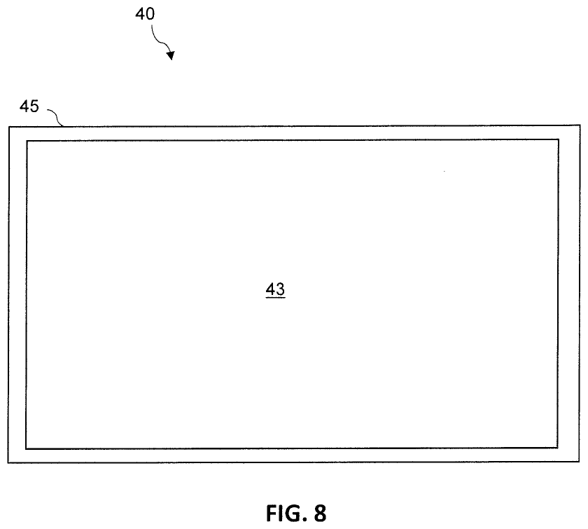

The plastic coated support blocks 40, 46 have a wooden core 43 with exposed sides thereof being coated with a plastic layer 45, as illustrated in FIGS. 7 and 8. The wooden core 43 may be generally referred to as a wooden support block. The wooden core 43 includes upper and lower surfaces with a pair of spaced apart sides extending therebetween, and the plastic layer 45 is on the pair of spaced apart sides but not on the upper and lower surfaces.

The plastic layer 45 offers a number of advantages. One advantage is that the plastic layer 45 increases durability over exposed wooden support blocks. This is particularly helpful to better withstand impacts from fork lift tines. The plastic layer 45 adds toughness to the wooden core 43 which helps to extend the life of the support blocks.

Another advantage of plastic coated support blocks 40, 46 is that the plastic layer 45 may have a desired color. A coloring material, for example, may be added when the plastic layer 45 is formed so as to provide the desired color. Colored support blocks may be used to identify the manufacturer or owner of the pallet 10. This avoids having to paint the support blocks 40, 46 to provide the desired color.

Yet another advantage of plastic coated support blocks 40, 46 is that the plastic layer 45 can have indicia incorporated therein. Indicia could include logos, for example. This avoids having to use stencils to paint indicia onto the support blocks 40, 46.

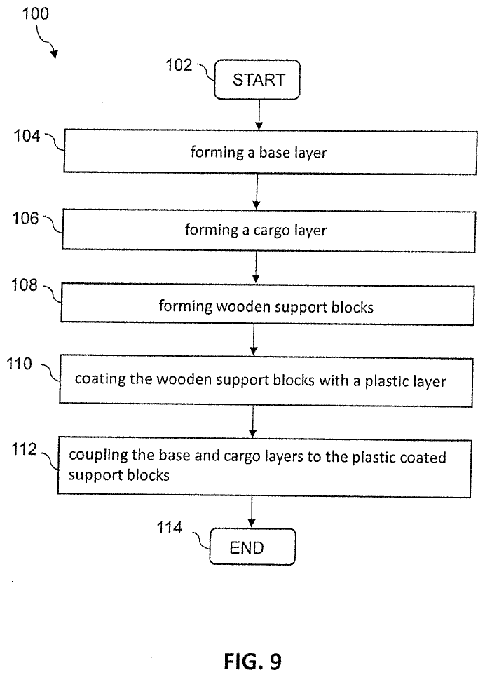

Referring now to the flowchart 100 illustrated in FIG. 9, a method for forming the wooden pallet 10 will be discussed. From the start (Block 102), the method includes forming a base layer 20 at Block 104, and forming a cargo layer 30 at Block 106. Wooden support blocks 43 are formed at Block 108, and then the wooden support blocks 43 are coated with a plastic layer 45 at Block 110 to form the plastic coated wooden support blocks 40, 46. The base and cargo layers 20, 30 are coupled to the plastic support blocks 40, 46 at Block 112. The method ends at Block 114.

Each wooden support block 43 includes upper and lower surfaces with a pair of spaced apart sides extending therebetween, and the plastic layer 45 is on the pair of spaced apart sides but not on the upper and lower surfaces. The plastic coated wooden support blocks 40, 46 are formed before being coupled to the base and cargo layers 20, 30. The base and cargo layers 20, 30 are formed as wooden base and cargo layers, with exposed wooden surfaces thereof not being coated with a plastic layer.

Referring now to FIGS. 7 and 8, the plastic layer 45 on one of the plastic coated support blocks 40 will be discussed in greater detail. As discussed above, the plastic layer 45 surrounds the wood core 43. The plastic layer 45, as illustrated, is on all four sides of the support black 40 but not on the upper and lower surfaces of the support block 40. However, in other embodiments, the plastic layer 45 may be on one, two or three sides of the wood core 43 instead of all four sides.

In the illustrated pallet 10, all of the wood cores 43 have a plastic layer 45. However, this may not be the case for all embodiments. For instance, the centermost support block may not be coated with a plastic layer 45.

The plastic layer 45 may be applied via spray or other means to the sides of the wood core 43. The plastic layer 45 may be applied via a two part A & B spray system. Material is sprayed at high pressure and held at elevated temperatures to induce a catalyst action/chain extending, as readily appreciated by those skilled in the art.

A thickness of the resulting plastic layer 45 is within a range of 20-90 mils. In other embodiments, the thickness may be less than 20 mils, or greater than 90 mils. The pre-polymers, or quasi-polymers in the material can vary based on the desired properties of the material. Below is an example of a polyurea layer or structure.

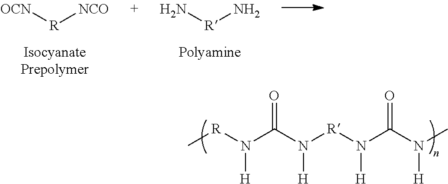

In other embodiments, the polyurea may be replaced with a hybrid urea/urethane component or a polyurethane system. The above coating is not to be limiting, where other coating formulations may be used as readily appreciated skilled in the art.

Referring back to FIGS. 1-6, the following is a discussion of the illustrated pallet 10 in greater detail. The illustrated pallet is provided for discussion purposes. The features of the illustrated pallet 10 are not to be limiting. The concept of wooden support blocks 43 coated with a plastic layer 45 is applicable to pallets in general and is not limited to the illustrated pallet 10.

The cargo layer 30 includes a pair of spaced apart wooden end deck boards 32, and a pair of wooden intermediate deck boards 34 between the end deck boards. In this embodiment, each end deck board 32 and an immediately adjacent intermediate deck board 34 are butted against one another. Pallet durability is significantly improved by having the end deck boards 32 butt up against the immediately adjacent intermediate deck boards 34.

Also included within the cargo layer 30 are a pair of spaced apart wooden connector boards 36 and a wooden intermediate connector board 37. The connector boards 36 and the intermediate connector boards 37 are orthogonal to the end deck boards 32 and the intermediate deck boards 34. The end deck boards 32 and the intermediate deck boards 34 are positioned on the connector boards 36.

The base layer 20 includes bottom deck boards 22, 26 orientated in the same direction as the end deck boards 32 and the intermediate deck boards 34 in the cargo layer 30. The bottom deck boards 22, 26 are directly coupled to the plastic coated support blocks 40, 46.

The plastic coated support blocks include corner plastic coated support blocks 40 and center plastic coated support blocks 46 between the corner plastic coated support blocks 40. The corner plastic coated support blocks 40 and the center plastic coated support blocks 46 each have a rectangular shape, and the center plastic coated support blocks 46 are orthogonal to the corner plastic coated support blocks 40.

A rectangular shape has unequal adjacent sides so that a length and width of a rectangular shaped corner plastic coated support block 40 are not equal as in a square shaped corner plastic coated support block 40. More particularly, the bottom deck boards include a pair of bottom end deck boards 22, and a bottom center deck board 26 between the pair of bottom end deck boards 22. A width of the bottom center deck board 26 is greater than a width of the bottom end deck boards 22. The center plastic coated support blocks 46 are orthogonal to the corner plastic coated support blocks 40 so that the center plastic coated support blocks 46 extend across the width of the bottom center deck board 26.

In other embodiments, the corner plastic coated support blocks 40 and the center plastic coated support blocks 46 may have a square or circular shape. When the plastic coated support blocks 40, 46 are the same size, then a width of the bottom center deck board 26 is equal to a width of the bottom end deck boards 22.

In the illustrated wooden pallet 10, a size of each end deck board 32 and a corresponding intermediate deck board 34 butted thereagainst have the same dimensions. For example, a width of the end deck board 32 and the intermediate deck board 34 butted thereagainst may be 145 mm, for example. In another example, the width may be 78 mm.

In other embodiments, the size of each end deck board 32 and a corresponding intermediate deck board 34 have different dimensions. For example, the width of the end deck board 32 may be 78 mm and the width of the corresponding intermediate deck board 34 may be 98 mm.

Traditionally, the intermediate deck boards in wooden pallets have a width that is less than a width of the end deck boards. In addition, traditionally there is a gap between the end deck boards and the adjacent intermediate deck boards. In the illustrated wooden pallet 10, pallet durability is significantly improved when there is no gap between the end deck boards 32 and the immediately adjacent intermediate deck boards 34, particularly with the end deck boards 32 and the immediately adjacent intermediate deck boards 34 having a same width.

The cargo layer 30 also includes at least one additional intermediate deck board 35 positioned between the intermediate deck boards 34 that are butted against the end deck boards 32. This additional intermediate deck board 35 is positioned so that there is a gap between the adjacent intermediate deck boards 34. The dimensions of the end deck boards 32 and the intermediate deck boards 34 as well as additional intermediate deck boards 35 positioned between the intermediate deck boards 34 are selected and spaced such that coverage of the cargo layer 30 is within a range of 70-85 percent of a maximum total surface area of the cargo layer 30 when there are no gaps between the boards.

A width of the intermediate deck board 35 may be the same as a width of the intermediate deck boards 34 butted against the end deck boards 32. Alternatively, in other embodiments, this intermediate deck board 35 may have a different width.

As noted above, the illustrated wooden pallet 10 also includes center plastic coated support blocks 46 between the corner plastic coated support blocks 40. When the plastic coated support blocks 40, 46 are rectangular shaped, the center plastic coated support blocks 46 may be positioned in a different orientation to the corner support blocks 40. In other words, the center plastic coated support blocks 46 may be at a 90 degree angle to the corner plastic coated support blocks 40. In other embodiments, orientation of the center plastic coated support blocks 46 is the same as orientation of the corner plastic coated support blocks 40.

Another feature of the illustrated wooden pallet 10 is the edges of each plastic coated support block 40 are angled or chamfered. The angled edges 42 may be within a range of about 25 to 75 degrees, for example, to deflect the impact force of the forklift tines should such an impact occur. The illustrated edges are angled at 45 degrees.

When the edges 42 of each plastic coated support block 40 are angled, the corresponding outermost edges 38 of the end deck boards 32 are angled to match the angled edges 42 in the support blocks 40. The corresponding outermost edges 39 of the connector boards 36 in the cargo layer 30 are angled to also match the angled edges 42 in the plastic coated support blocks 40. The corresponding outermost edges 28 of the deck boards 22 in the base layer 20 are also angled to match the angled edges 42 in the plastic coated support blocks 40.

Many modifications and other embodiments will come to the mind of one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

That which is claimed:

1. A method for making a pallet comprising:
forming a base layer;
forming a cargo layer;
forming a plurality of wooden support blocks;
coating a plurality of wooden support blocks with a plastic layer to form a plurality of plastic coated wooden support blocks; and
coupling the base and cargo layers to the plurality of plastic coated wooden support blocks, with a gap being formed therebetween, for receiving a lifting member.

2. The method according to claim 1 wherein each wooden support block includes upper and lower surfaces with a pair of spaced apart sides extending therebetween, and wherein the plastic layer is on the pair of spaced apart sides but not on the upper and lower surfaces.

3. The method according to claim 1 wherein the coating comprises adding a coloring material to the plastic layer so that each plastic coated wooden support block has a desired color.

4. The method according to claim 1 wherein the coating comprises adding indicia to the plastic layer so that each plastic coated wooden support block displays the indicia.

5. The method according to claim 4 wherein the indicia is configured as a logo.

6. The method according to claim 1 wherein the coating comprises a spray coating.

7. The method according to claim 1 wherein the plastic layer comprises a polyurea layer.

8. The method according to claim 1 wherein the plastic layer has a thickness within a range of 20-90 mils.

9. The method according to claim 1 wherein the base and cargo layers are formed as wooden base and cargo layers, with exposed wooden surfaces thereof not being coated with the plastic layer.

10. The method according to claim 1 wherein the cargo layer is formed to comprise:
a pair of spaced apart connector boards;
a pair of spaced apart end deck boards on the pair of connector boards, with the end deck boards being orthogonal to the pair of connector boards; and
a pair of spaced apart intermediate deck boards on the pair of connector boards, with each intermediate deck board being orthogonal to the pair of connector boards and butted against a respective end deck board.

11. A pallet comprising:
a base layer;
a cargo layer; and
a plurality of plastic coated wooden support blocks coupled between said base and cargo layers, with a gap being formed therebetween for receiving a lifting member, with each plastic coated wooden support block comprising a plastic layer on exposed sides thereof.

12. The pallet according to claim 11 wherein each plastic coated wooden support block includes upper and lower surfaces with a pair of spaced apart sides extending therebetween, and wherein the plastic layer is on the pair of spaced apart sides but not on the upper and lower surfaces.

13. The pallet according to claim 11 wherein the plastic layer comprises a colored material there so that each plastic coated wooden support block has a desired color.

14. The pallet according to claim 11 wherein the plastic layer comprises an exposed indicia formed therein.

15. The pallet according to claim 14 wherein the indicia is formed as a logo.

16. The pallet according to claim 11 wherein the plastic layer comprises a polyurea layer.

17. The pallet according to claim 11 wherein the plastic layer has a thickness within a range of 20-90 mils.

18. The pallet according to claim 11 wherein said base and cargo layers comprise wooden base and cargo layers, with exposed wooden surfaces thereof not being coated with the plastic layer.

19. The pallet according to claim 11 wherein said cargo layer comprises:
a pair of spaced apart connector boards,
a pair of spaced apart end deck boards on the pair of connector boards, with the end deck boards being orthogonal to the pair of connector boards, and
a pair of spaced apart intermediate deck boards on the pair of connector boards, with each intermediate deck board being orthogonal to the pair of connector boards and butted against a respective end deck board.

20. The pallet according to claim 11 wherein said base layer comprises a pair of bottom end deck boards and a bottom center deck board between said pair of bottom end deck boards, with a width of said bottom center deck board being greater than a width of said bottom end deck boards; and
wherein said plurality of plastic coated support blocks comprise corner plastic coated support blocks and center plastic coated support blocks between the corner plastic coated support blocks, with said corner plastic coated support blocks and said center support blocks each having a same sized rectangular shape; and
wherein said center plastic coated support blocks coupled to said bottom center deck board are orthogonal to said corner plastic coated support blocks so that said center plastic coated support blocks extend across the width of said bottom center deck board.
